(19) United States
(12) Patent Application Publication
(10) Pub. No.: US 2017/0191585 A1
(43) Pub. Date: Jul. 6, 2017

(54) REINFORCED THERMOPLASTIC DUCTS AND THEIR MANUFACTURE

(71) Applicant: The Boeing Company, Chicago, IL (US)

(72) Inventor: Douglas Dean Maben, Snohomish, WA (US)

(73) Assignee: The Boeing Company, Chicago, IL (US)

(21) Appl. No.: 14/989,763

(22) Filed: Jan. 6, 2016

(51) Int. Cl. F16L 9/133; B32B 37/08; B32B 5/02; B32B 37/06

(52) U.S. Cl. CPC F16L 9/133; B32B 37/06; B32B 37/08; B32B 5/024; B32B 5/026; B32B 2597/00; B32B 2262/106; B32B 2262/105; B32B 2262/101; B32B 2262/103

(57) ABSTRACT

Duct segments that define a channel for conveying a fluid, where the duct wall includes a sheath of reinforcing fabric incorporating multiple reinforcing fibers, and a thermoplastic fused with the sheath of reinforcing fabric. The duct segments may be prepared by wrapping a mandrel configured to define the inner mold line of a desired duct segment with a thermoplastic film, enveloping the wrapped mandrel with a reinforcing sheath incorporating reinforcing fibers; wrapping the enveloped mandrel with another thermoplastic film to form a multilayer duct segment precursor; enclosing the mandrel and multilayer duct segment precursor within an outer mold defining the outer mold line for the desired duct segment; heating the duct segment precursor at a temperature and for a time sufficient to fuse the layers of the multilayer duct segment precursor; and then cooling the resulting duct segment.

### FIELD

This disclosure relates to duct segments and their manufacture, and more specifically to thermoplastic duct segments with integral reinforcing fibers, and their manufacture.

### BACKGROUND

The distribution and delivery of fluids, such as heating or cooling fluids, may require a system or network of conduits to convey the fluids to their intended locations, often referred to as ducts.

A commercial aircraft may include miles of ducts that may be used to deliver conditioned air to a passenger cabin or flight deck, circulate cooling air through avionics components, or deliver heated air to deicing systems, among many such applications.

While the ducting used on commercial aircraft must possess the requisite strength, rigidity, and physical properties for their intended use, any incremental savings in manufacturing costs adds up quickly when considering the number of ducts needed for a single aircraft. Similarly, any incremental decrease in weight that can be accomplished for a duct network, without compromising the requisite physical properties for a given duct segment, can manifest as reduced operating costs by way of fuel savings.

### SUMMARY

The present disclosure provides thermoplastic duct segments and methods of manufacturing thermoplastic duct segments, where the duct segments incorporate reinforcing fibers.

In some aspects, the disclosure may provide a method of manufacturing a duct segment, the method including wrapping a mandrel configured to define the inner mold line of a desired duct segment with a thermoplastic film, enveloping that wrapped mandrel with a reinforcing sheath incorporating reinforcing fibers; wrapping the enveloped mandrel with another thermoplastic film to form a multilayer duct segment precursor; enclosing the mandrel and multilayer duct segment precursor within an outer mold defining the outer mold line for the desired duct segment; heating the duct segment precursor at a temperature and for a time sufficient to fuse the layers of the multilayer duct segment precursor; and then cooling the resulting duct segment.

In some aspects, the disclosure may provide duct segments, the duct segments having a duct wall defining a channel for conveying a fluid, where the duct wall includes a sheath of reinforcing fabric incorporating multiple reinforcing fibers, and a thermoplastic that is fused with the sheath of reinforcing fabric.

In some aspects, the disclosure may provide fused duct segments prepared by wrapping an internal form with a thermoplastic film; slipping a reinforcing sheath over the wrapped internal form; wrapping the reinforcing sheath with a second thermoplastic film; enclosing the wrapped internal form within an outer mold; heating the mold to fuse the thermoplastic films with the reinforcing sheath, and cooling the resulting fused duct segment.

The features, functions, and advantages may be achieved independently in various aspects of the present disclosure, or may be combined in yet other aspects further details of which can be seen with reference to the following description and drawings.

### BRIEF DESCRIPTION OF THE DRAWINGS

FIG. 1 is a schematic depiction of an illustrative mandrel of the present disclosure.

FIG. 2 is a schematic depiction of the mandrel of FIG. 1 being wrapped in a first thermoplastic film.

FIG. 3 is a schematic depiction of an illustrative wrapped mandrel.

FIG. 4 is a schematic depiction of an illustrative reinforcing sheath and the wrapped mandrel of FIG. 3.

FIG. 5 is a schematic depiction of the reinforcing sheath of FIG. 4 enveloping the wrapped mandrel of FIG. 3.

FIG. 6 is a schematic depiction of an illustrative enveloped mandrel.

FIG. 7 is a schematic depiction of the enveloped mandrel of FIG. 6 being wrapped in a second thermoplastic film.

FIG. 8 is a schematic depiction of an illustrative multilayer duct segment precursor.

FIG. 9 is a schematic depiction of an illustrative outer mold of the present disclosure.

FIG. 10 is a schematic depiction of the multilayer duct segment precursor of FIG. 8 placed within the outer mold of FIG. 9.

FIG. 11 is a schematic depiction of the multilayer duct segment precursor of FIG. 8 enclosed by the outer mold of FIG. 9.

FIG. 12 is a schematic depiction of an illustrative reinforced thermoplastic duct segment of the present disclosure.

FIG. 13 is a schematic depiction of branched mandrel wrapped in a first thermoplastic film according to the present disclosure.

FIG. 14 is a schematic depiction of a reinforcing sheath configured to be applied to the wrapped branched mandrel of FIG. 13.

FIG. 15 is a schematic depiction of the reinforcing sheath of FIG. 14 enveloping the wrapped branched mandrel of FIG. 13.

FIG. 16 is a schematic depiction of the enveloped branched mandrel of FIG. 15 being wrapped in a second thermoplastic film.

FIG. 17 is a flowchart illustrating a method of manufacturing a reinforced thermoplastic duct segment according to the present disclosure.

FIG. 18 is a flowchart illustrating an alternative method of manufacturing a reinforced thermoplastic duct segment according to the present disclosure.

### DESCRIPTION

An advantageous composition for the manufacture of ducts may be lightweight, mechanically resilient, and capable of formulation to withstand desired operating conditions, such as high and/or low temperature extremes. Such properties are desirable in a variety of industrial environments, but may be particularly sought for the manufacture of commercial aircraft, particularly when the composition can additionally be prepared in an efficient and cost-effective manner.

Various embodiments of a thermoplastic reinforced duct segment having one or more such advantageous properties, and methods of manufacturing such thermoplastic reinforced duct segments, are described below and illustrated in the associated drawings. Unless otherwise specified, the disclosed duct segments and/or their various components may, but are not required to, contain at least one of the structure, components, functionality, and/or variations described, illustrated, and/or incorporated herein. Furthermore, the structures, components, functionalities, and/or variations described, illustrated, and/or incorporated herein in connection with the present teachings may, but are not required to, be included in other similar duct structures. Although disclosed as useful in the context of aircraft manufacture, the disclosed thermoplastic reinforced ducts, and the manufacture thereof, may have utility in any suitable application and appropriate environment, without limitation. The following description of various examples is merely exemplary in nature and is in no way intended to limit the disclosure, its application, or uses. Additionally, the advantages provided by the examples, as described below, are illustrative in nature and not all examples may provide the same advantages or the same degree of advantages.

### Definitions

Duct A duct may be an enclosed passage defining a channel for the conveyance of a fluid.
Fluid A substance with no fixed shape, such as a liquid or a gas, which flows under the application of an external pressure.
Duct Segment A subsection of a desired duct. A duct segment may be prepared individually and then combined with additional duct segments, which may be the same or different, to form a desired duct or duct network.
Duct Network A system comprising one or more ducts for conveying fluids to desired locations. A duct network may include a plurality of ducts, which may be the same or different.

Any given duct or segment of a duct may be branched or unbranched, and may be simple or complex (incorporating one or more curves and/or branches). In particular, a given duct or duct segment may incorporate one or more joggles, or preformed offset bends, in order to accommodate limited spatial availability or to route around an obstacle.

A duct network may incorporate multiple ducts or duct segments that may be arranged in sequence, may be arranged substantially in parallel, or in any combination thereof. Along its length, a given duct, segment of a duct, or portion of a duct segment may undergo a change in its cross-sectional geometry, cross-sectional area, or both. The change in cross-section geometry or area may be gradual or abrupt. Where the duct, duct segment, or portion of a duct segment undergoes a change in cross-sectional geometry, the change may correspond to a net increase or net decrease in cross-sectional area. The change in cross-sectional area may occur without altering the geometry of the cross-section, or its initial and final cross-sectional geometries may be different.

A given duct or duct segment may have any appropriate cross-sectional geometry, including but not limited to cross-sections that are partially or substantially circular, oval, oblong, rectangular, or square, or variations or combinations thereof.

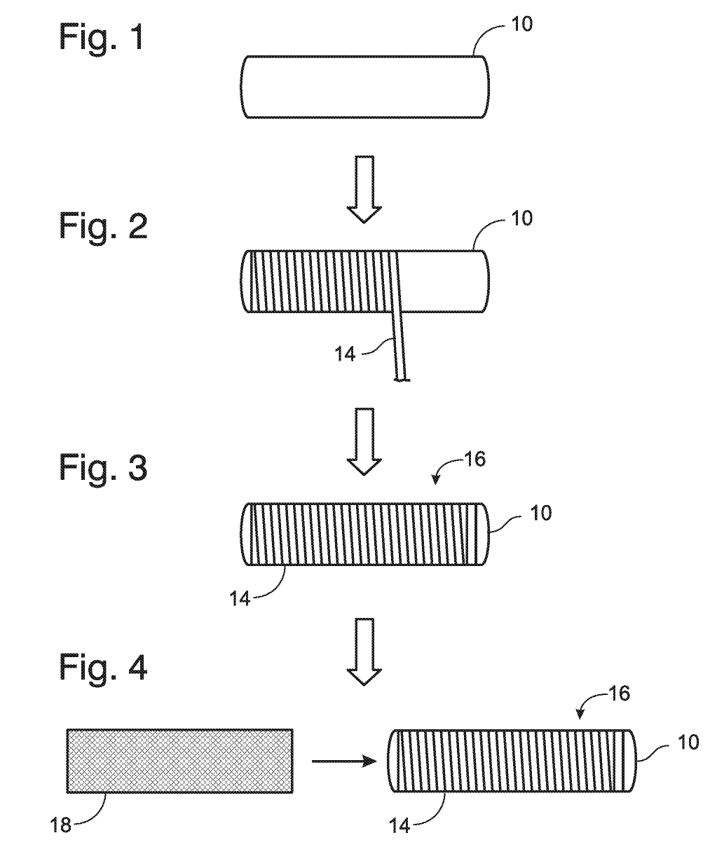

The manufacture of the duct segments of the present disclosure may begin with the selection of an appropriate mandrel 10, as shown in FIG. 1. The mandrel 10 is a form on which the desired duct segment may be assembled. In particular, the mandrel 10 may be selected and/or prepared so that the external surface 12 of the mandrel 10 defines the inner mold line for the desired duct segment 13.

Mandrel 10 may be prepared from any material that is compatible with the conditions under which the desired duct segment is manufactured. Mandrel 10 may be formed from plaster, for example, although the selection of a plaster mandrel may require the destruction of the mandrel in order to recover the desired duct segment.

In one aspect of the disclosure, mandrel 10 incorporates a silicone polymer, which material may confer upon the mandrel 10 a desirable degree of durability and chemical resistance. A silicone-containing mandrel may therefore permit reuse, leading to increased cost-effectiveness.

Where mandrel 10 incorporates a silicone polymer, or is otherwise rendered sufficiently flexible, the mandrel 10 may define a hollow mandrel interior. The mandrel 10 may additionally include a gas-tight fitting configured to permit the interior of mandrel 10 to be pressurized with a desired gas.

As shown in FIG. 2, the mandrel 10 may be wrapped by or within a first thermoplastic film 14. The first thermoplastic film 14 may be applied as a continuous strip or tape, for example using a spiral wrapping pattern as shown in FIG. 2. The strip or tape may be relatively narrow, for example having a width of 2 cm or less, or may be wider. As an alternative to a continuous strip or tape, the first thermoplastic film 14 may be applied as a series of discrete strips. In yet another alternative, the first thermoplastic film 14 may be applied to the mandrel 10 as a sheet of thermoplastic film that is sized appropriately and then wrapped around mandrel 10. Any of these application methods, or variations or combinations thereof, are suitable methods for applying the first thermoplastic film 14 to the mandrel 10, which is applied until mandrel 10 is covered to the desired extent by the first thermoplastic film 14, as shown by wrapped mandrel 16 in FIG. 3.

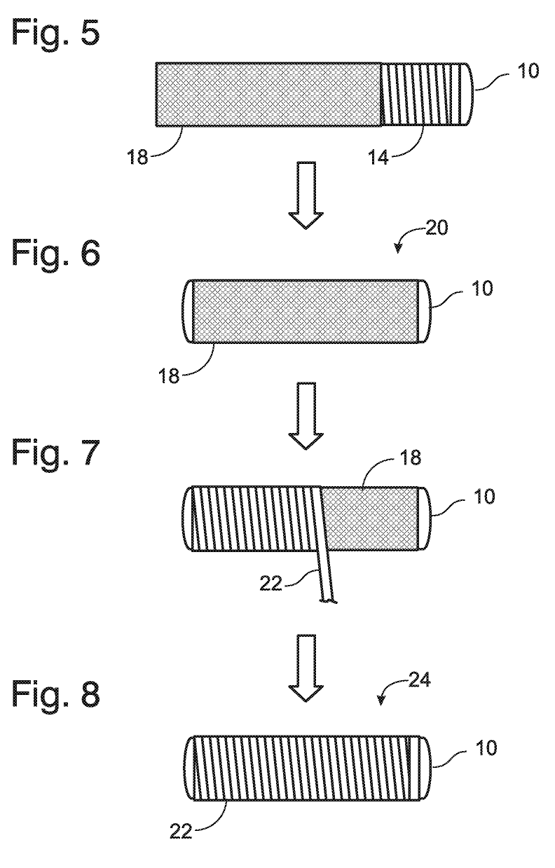

The wrapped mandrel 16 may then be enveloped by a reinforcing sheath 18, shown in FIG. 4 Reinforcing sheath 18 may include a plurality of reinforcing fibers that are interlocked so as to form a fabric 20. The fabric 20 is sized so as to fit snugly when applied to the wrapped mandrel 16, and further to define the desired size and shape of the desired duct segment 13. In one aspect of the present disclosure, the reinforcing sheath 18 may be substantially tubular and/or cylindrical, and sized so that it may be slipped onto the wrapped mandrel 16, as depicted in FIGS. 4 and 5.

Once the wrapped mandrel 16 is enveloped by reinforcing sheath 18, the resulting enveloped mandrel 20, as shown in FIG. 6, may be wrapped by or within a second thermoplastic film 22, as shown in FIG. 7. Second thermoplastic film 22 may be the same or different than first thermoplastic film 14 in composition and/or morphology. That is, where first thermoplastic film 16 may have the form of a continuous strip of thermoplastic film, second thermoplastic film 22 may have the form of a sheet of thermoplastic film, or vice versa. Optionally, after applying the second thermoplastic film 22, an additional reinforcing sheath or reinforcing fabric section may be applied over the second thermoplastic film 22, and the additional reinforcing sheath or fabric section may be wrapped by yet another thermoplastic film. The application of multiple layers of reinforcing fabric and/or thermoplastic film may be used to create duct segments or regions of duct segments having greater strength, stiffness, and/or wear resistance.

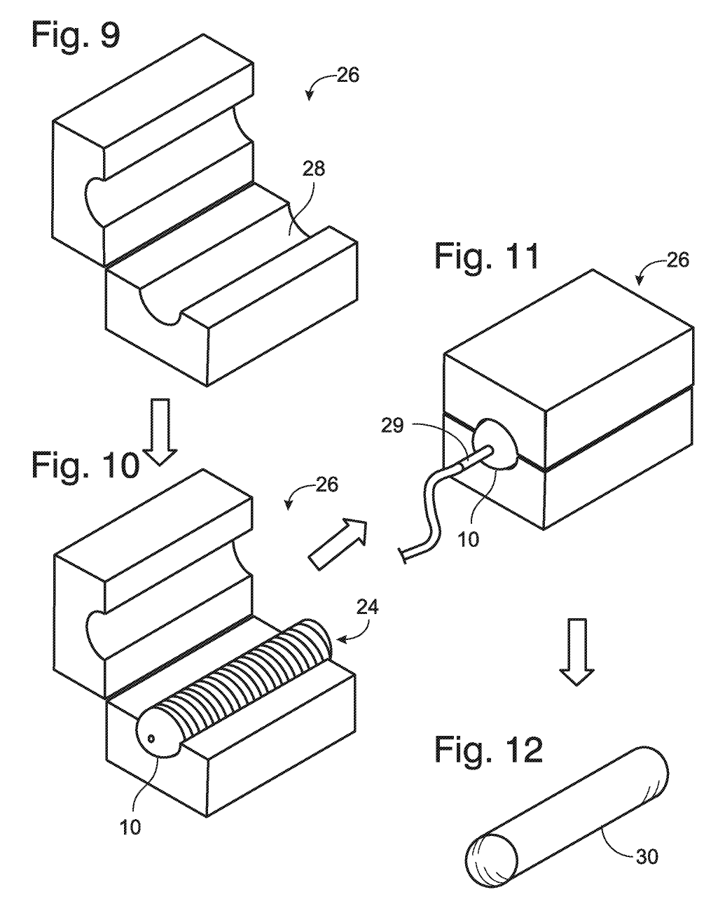

Once the desired number of layers of reinforcing fabric and thermoplastic film have been applied, the resulting multilayer duct segment precursor 24, as shown in FIG. 8, may be heated to form the desired duct segment 13. FIG. 9 depicts an outer mold 26 having an inner surface 28 that is configured to define an outer mold line for the desired duct segment 13. The outer mold 26 may be configured to enclose the multilayer duct segment precursor 24. That is, multilayer duct segment precursor 24 may be placed within outer mold 26, as shown in FIG. 10, and outer mold 26 may be closed so that the multilayer duct segment precursor 24 is enclosed by the outer mold 26, as in FIG. 11.

Once enclosed by the outer mold 26, the multilayer duct segment precursor 24 may be heated at a temperature and for a time sufficient that the thermoplastics making up the first thermoplastic film 14 and the second thermoplastic film 22 each reach a temperature above the glass transition temperature (T_{g}) for that polymer. Heating is continued until the thermoplastics flow sufficiently that the thermoplastic intercalates into the interstices formed by the reinforcing fibers of the reinforcing sheath 18.

The multilayer duct segment precursor 24 may be heated using any appropriate heating source. In one implementation, the outer mold 26 containing the multilayer duct segment precursor 24 may be placed within an oven, and the entire assembly may be heated. In an alternative implementation, one or more of the mandrel 10 and the outer mold 26 may incorporate heating elements configured so as to sufficiently heat the multilayer duct segment precursor 24.

Where mandrel 10 is composed of a flexible material, such as a silicone-containing material, and incorporates a hollow mandrel interior, the mandrel 10 may be fitted with a source of pressurized gas, such as gas-tight fitting 29 shown in FIG. 11. When pressurized, and particularly during heating, mandrel 10 exerts an outward pressure on the multilayer duct segment precursor 24 which is opposed by the inner surface 28 of the outer mold 26, resulting in a duct segment having a desired wall thickness.

Once it has been sufficiently heated, and then cooled to a temperature below the glass transition temperature (T_{g}) for the thermoplastic polymers of first thermoplastic film 14 and second thermoplastic film 22, the multilayer duct segment precursor may become a unitary reinforced thermoplastic duct segment 30 as shown in FIG. 12, that substantially corresponds to the desired duct segment 13. By careful selection of the thermoplastic(s) used, and the reinforcing fibers incorporated into the reinforcing sheath, the resulting duct segment 30 may possess a desired combination physical and chemical properties, including but not limited to heat-resistance, abrasion-resistance, leakage-resistance, corrosion-resistance, flexibility, and high strength-per-weight.

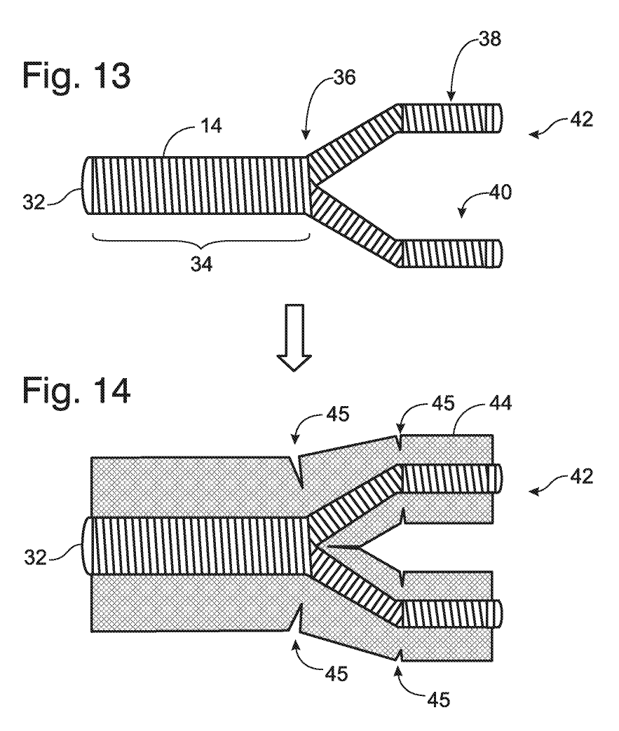

A mandrel 32 for the manufacture of a complex duct segment is shown in FIG. 13, having already been wrapped by a first thermoplastic film 14. Mandrel 32 includes a portion 34 that defines a greater cross-sectional area, and a bifurcation 36 that creates a first branch 38 and a second branch 40. The first thermoplastic film 14 may be applied to the surface of mandrel 32 as a strip or tape, as shown in FIG. 13.

The wrapped mandrel 42 may then be enveloped by a reinforcing sheath 44, as shown in FIG. 14. As mandrel 32 incorporates a bifurcation 36, reinforcing sheath 44 cannot be applied as a single snug-fitting preshaped sheath. Alternatively, the reinforcing fabric may be shaped so as to fold and/or wrap snugly around wrapped mandrel 42. As shown in FIG. 14, a flattened reinforcing sheath 44 is manufactured to correspond to the size and shape of wrapped mandrel 42, and includes a plurality of slits 45 that permit the reinforcing fabric 43 of the reinforcing sheath 44 to wrap snugly around the wrapped mandrel 42 while minimizing overlap of the reinforcing fabric. Alternatively, or in addition, reinforcing sheath 44 may be shaped so as to minimize seams in the reinforcing sheath 44 once applied to the wrapped mandrel 42.

Where a seam or overlap is formed in reinforcing sheath 44, the seam or overlap may be temporarily or permanently sealed using an appropriate adhesive, by solvent welding, and/or by heat-sealing, provided that the reinforcing fabric is compatible with such methods.

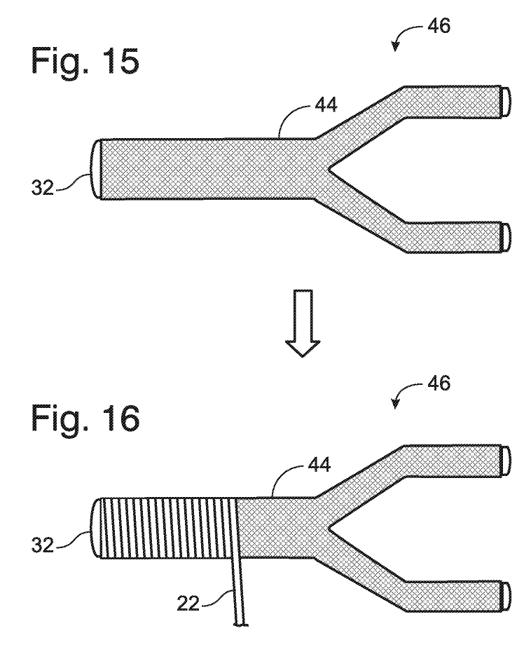

Once wrapped mandrel 42 has been enveloped by the reinforcing sheath 44, the resulting enveloped mandrel 46, as shown in FIG. 15, may be wrapped by or within the second thermoplastic film 22, as shown in FIG. 16. The resulting multilayer duct segment precursor 48 may then be placed within an appropriate outer mold and heated at a temperature and for a time sufficient that the thermoplastics making up the first thermoplastic film 14 and the second thermoplastic film 22 each reach a temperature above the glass transition temperature (T_{g}) for that polymer and the thermoplastics flow. After cooling to a temperature below the glass transition temperature (T_{g}) for the thermoplastic polymers of first thermoplastic film 14 and second thermoplastic film 22, the multilayer duct segment precursor may become a complex unitary reinforced thermoplastic duct segment.

The reinforced thermoplastic duct segments of the present disclosure may be manufacturing with an appropriate selection of a first thermoplastic film 14, a reinforcing sheath (18, 44) and second thermoplastic film 22 so that the resulting duct segment has an appropriate strength, weight, and flexibility appropriate for its intended application. In some aspects of the present disclosure, for example where high strength and low weight may be advantageous, the first thermoplastic film 14, a reinforcing sheath (18, 44) and second thermoplastic film 22 may be selected so that the resulting duct segment has a duct wall thickness in the range of 0.5 mm to 2 mm, or in an alternative implementation, a duct wall thickness in the range of 0.5 mm to 1 mm. Similarly, for selected applications, the reinforced thermoplastic duct segments of the present disclosure may be manufactured to define a fluid channel that is 300 mm or less in diameter.

### Thermoplastic Film

A thermoplastic, or thermosoftening plastic, is typically a high molecular weight organic polymer. Unlike thermosetting polymers, which typically undergo irreversible curing, a thermoplastic may be reshaped by warming it to a temperature above its glass transition temperature (T_{g}) but below its melting point (Tₘ), where the thermoplastic becomes pliable or moldable. Upon cooling to a temperature below its glass transition temperature, the thermoplastic again hardens.

A variety of thermoplastic polymers are known, and specific polymers or mixed polymers may be selected so as to achieve a desired combination of physical and/or chemical properties. Thermoplastic polymers suitable for one or both of the first thermoplastic film 14 and second thermoplastic film 22 may include, without limitation, acrylonitrile butadiene styrene (ABS); polyamides, such as Nylon and including Nylon-6,6; polybenzimidazole (PBI); polycarbonates, such as LEXAN; Polyether sulfone (PES); polyether ether ketone (PEEK); polyether ketone ketone (PEKK); polyetherimide (PEI); polyethylene, including ultra-high molecular weight polyethylene (UHMWPE); high-density polyethylene (HDPE), medium-density polyethylene (MDPE), low-density polyethylene (LDPE); cross-linked polyethylene (XLPE or PEX); polyphenylene oxide (PPO); polyphenylene sulfide (PPS); polypropylene (PP); polystyrene; polyvinyl chloride (PVC); fluoropolymers, including polytetrafluoroethylene (PTFE), polyvinyl fluoride (PVF), and polyvinylidene fluoride (PVDF), among others. Thermoplastic polymers suitable for applications that involve very low or very high temperatures, such as for cooling and/or heating applications, may include cross-linked polyethylene polymers, among others.

The amount of thermoplastic incorporated into the duct segments of the present disclosure depends upon both the thickness of the thermoplastic film used to wrap the mandrel 14 and sheathed enveloped mandrel 20 as well as the degree of overlap created when applying the thermoplastic films. The first thermoplastic film 14 and second thermoplastic film 22 may be any thickness sufficient to, in combination, provide adequate thermoplastic to fuse with and integrate the reinforcing fibers of the reinforcing sheath 18 into a matrix of thermoplastic. That is, the first thermoplastic film 14 and second thermoplastic film 22 are selected to have a thickness, which may be the same or different, sufficient to provide adequate thermoplastic material to form a duct having the desired degree of structural strength. Similarly, the first thermoplastic film 14 and second thermoplastic film 22, and optionally any additional applied layers of reinforcing fabric and thermoplastic film, are selected to be sufficiently thin that the overall weight of the resulting reinforced thermoplastic duct segment 30 is as low as desired.

In some implementations, the first thermoplastic film 14 and second thermoplastic film 22 are independently selected to have a thickness of about 0.2 mm-1.0 mm.

In some implementations of the present disclosure, the first and/or second thermoplastic film includes a thermoplastic selected to have a glass transition temperature (T_{g}) above 120° C., so that the resulting duct segment may be suited for applications requiring resistance to elevated temperatures.

### Reinforcing Fibers

As used herein, a reinforcing fiber may have a continuous or non-continuous length. The term “fiber” is meant to include monofilaments and/or multifilament, without limitation. Alternatively, or in addition, the term “yarn” may be used to refer to a continuous strand or a plurality of strands spun from a group of fibers, filaments or other materials which can be twisted, untwisted or laid together. Alternatively, or in addition, the term “strand” may be used to refer to a plurality of aligned, aggregated fibers or filaments.

The reinforcing fibers of the present disclosure may have a relatively small diameter (e.g., from about 50 micrometers to about 300 micrometers) or a relatively largely diameter (e.g., from about 300 micrometers to about 1,000 micrometers), in any combination.

The reinforcing fiber or fibers of the reinforcing fabric may be selected from the group consisting of: ceramics, glass, minerals, thermoset polymers, thermoplastic polymers, elastomers, metal alloys, and any combinations thereof.

Where the reinforcing fiber includes a polymer composition, the fiber may be prepared from polyester, polyamide (e.g., Nylon 6,6), polyvinyl acetate, polyvinyl alcohol, polypropylene, polyethylene, acrylic, cotton, rayon, and fire retardant (FR) versions of all the aforementioned materials when extremely high temperature ratings are not required. If higher temperature ratings are desired along with FR capabilities, then the reinforcing fibers may include, by way of example and without limitation, materials including meta-Aramid fibers (sold under names Nomex®, Conex®, for example), para-Aramid (sold under the tradenames Kevlar®, Twaron®, for example), polyetherimide (PEI) (sold under the tradename Ultem®, for example), polyphenylene sulfide (PPS), liquid crystal thermoset (LCT) resins, polytetrafluoroethylene (PTFE), and polyether ether ketone (PEEK).

Where the reinforcing fiber includes an inorganic fiber, the reinforcing fiber may include fiberglass, basalt, silica and ceramic. For example, the inorganic fiber may include inorganic fibers such as fused silica fiber (e.g., Astroquartz® continuous fused silica fibers) or non-vitreous fibers such as graphite fiber, silicon carbide fiber (e.g., NICALON™ ceramic fiber available from Nippon Carbon Co., Ltd. of Japan) or fibers of ceramic metal oxide(s) (which can be combined with non-metal oxides, e.g., SiO₂) such as thoria-silica-metal (III) oxide fibers, zirconia-silica fibers, alumina-silica fibers, alumina-chromia-metal (IV) oxide fiber, titania fibers, and alumina-boria-silica fibers (e.g., 3M™ Nextel™ 312 continuous ceramic oxide fibers). These inorganic fibers may be particularly useful for the manufacture of ducts or duct segments intended for high temperature applications. Where the reinforcing fiber includes a high temperature resistant ceramic fiber, the ceramic fiber may be resistant to temperatures greater than 500 degrees Celsius (e.g., greater than 1200 degrees Celsius).

In some implementations, the reinforcing fiber may include a metal or metal alloy which may confer conductivity on the resulting duct segment. In some implementations, such as for corrosion resistant applications, the reinforcing fabric may include one or more fibers of nickel-chromium based alloys (e.g., INCONEL® alloy 718), aluminum, stainless steel, such as a low carbon stainless steel, for example, SS316L, which has high corrosion resistance properties. Other conductive continuous strands of metal wire may be used, such as, for example, copper, tin or nickel plated copper, and other metal alloys. These conductive continuous strands may be used in conductive applications. In implementations where the reinforcing fiber is a multifilament, the individual filaments of the multifilament may each have a diameter from about 50 micrometers to about 300 micrometers (e.g., from about 100 micrometers to about 200 micrometers).

### Reinforcing Sheath

Reinforcing sheath 18 may be prepared from a reinforcing fabric that incorporates a plurality of reinforcing fibers, as described above. Typically, a reinforcing fabric that is a woven fabric is made or constructed by interlacing a plurality of threads or fibers, including one or more reinforcing fibers, into a fabric. Alternatively, a reinforcing fabric that is a knitted fabric is made or constructed by interlocking loops of a plurality of threads or fibers, including one or more reinforcing fibers, into a fabric. Where a reinforcing fabric of the present disclosure incorporates more than one type of reinforcing fiber, the reinforcing fibers may be the same or different.

In some implementations, the reinforcing fabric includes one or more reinforcing fibers in a single layer. Alternatively, the reinforcing fabric may include plural layers. The plural layers may be present throughout the fabric, and therefore throughout the resulting duct segment 30, or plural layers of reinforcing fabric may be selectively disposed in preselected locations in order to reinforce the thickness and/or strength of an area of expected high stress or wear in the final duct segment. Alternatively, or in addition, multiple applications of reinforcing fabric may be used to create multiple layers at preselected locations of the reinforcing sheath.

In some implementations, the reinforcing fabrics and reinforcing sheaths of the present disclosure may be prepared using a plurality of reinforcing fibers with commercially available knitting machines. In particular, where the knitting machines is a Computer Numerically Controlled (CNC) knitting machine, the resulting reinforcing sheath may be manufactured at production level speed that may nevertheless accurately fit the mandrel 14. The reinforcing sheaths may be knit into net-shapes and fabrics containing spatially differentiated zones, both simple and complex, directly from the knitting machine through conventional bind off and other apparel knitting techniques. Exemplary shapes suitable for application to a complementary mandrel include simple cylindrical or conical shapes, shapes incorporating complex curves, variable diameters, and/or cross-section shapes, and linear and complex shapes, among others.

The reinforcing sheaths of the present disclosure may be woven, knit, and/or otherwise fabricated so as to yield a reinforcing sheath having a configuration that is complementary with mandrel 14. Where the reinforcing sheath is prepared using a CNC fabrication method, the reinforcing sheath may be manufactured direction in the desired shape complementary to mandrel 14. Alternatively, the reinforcing fabric may be a reinforcing fabric sheet that may be shaped as needed and applied to the wrapped mandrel 16, wrapped tightly around the wrapped mandrel 16, and fixed in place using an appropriate sealant, adhesive, or joining technique.

### EXAMPLES, COMPONENTS, AND ALTERNATIVES

The following examples describe selected aspects of exemplary reinforced thermoplastic ducts and their manufacture. These examples are intended for illustration and should not be interpreted as limiting the entire scope of the present disclosure. Each example may include one or more distinct inventions, and/or contextual or related information, function, and/or structure.

### Example 1

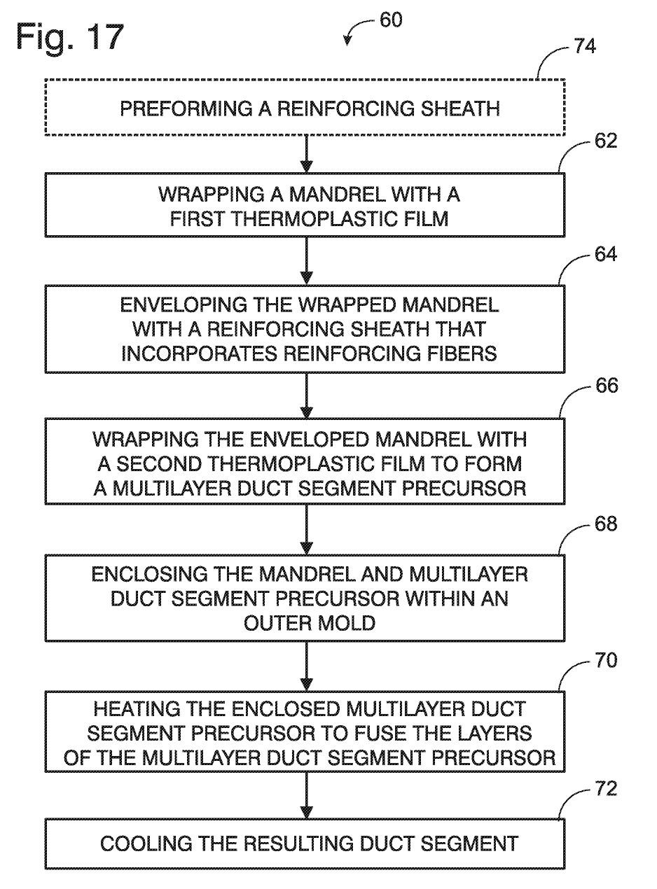

FIG. 17 illustrates a flowchart 60 of an illustrative method of manufacturing a reinforced thermoplastic duct segment. The method may include wrapping a mandrel with a first thermoplastic film, where the mandrel is configured to define an inner mold line for a desired duct segment, at 62 of flowchart 60. The wrapped mandrel may be enveloped with a reinforcing sheath, where the reinforcing sheath incorporates reinforcing fibers, at 64 of flowchart 60. The enveloped mandrel may be wrapped with a second thermoplastic film to form a multilayer duct segment precursor, at 66 of flowchart 60. The mandrel and multilayer duct segment precursor may be enclosed within an outer mold configured to define an outer mold line for the duct segment, at 68 of flowchart 60. The enclosed multilayer duct segment precursor may be heated at a temperature and for a time sufficient to fuse the layers of the multilayer duct segment precursor, at 70 of flowchart 50. The resulting duct segment may then be cooled, at 72 of flowchart 60. The illustrative method may optionally further include preforming the reinforcing sheath, at 74 of flowchart 60.

### Example 2

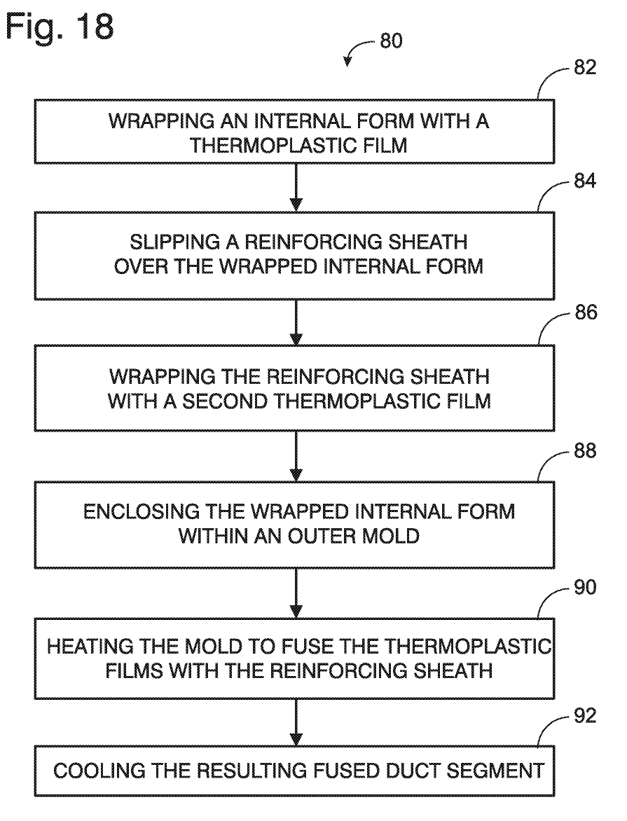

FIG. 18 illustrates a flowchart 80 of an illustrative method of manufacturing a reinforced thermoplastic duct segment. The method may include wrapping an internal form with a thermoplastic film, at 82 of flowchart 80. The method may include slipping a reinforcing sheath over the wrapped internal form, at 84 of flowchart 80. The method may include wrapping the reinforcing sheath with a second thermoplastic film, at 86 of flowchart 80. The method may include enclosing the wrapped internal form within an outer mold, at 88 of flowchart 80. The method may include heating the mold to fuse the thermoplastic films with the reinforcing sheath, at 90 of flowchart 80. The method may further include cooling the resulting fused duct segment, at 92 of flowchart 80.

### Example 3

This section describes additional aspects and features of the duct segments of the present disclosure, and their manufacture, presented without limitation as a series of paragraphs, some or all of which may be alphanumerically designated for clarity and efficiency. Each of these paragraphs can be combined with one or more other paragraphs, and/or with disclosure from elsewhere in this application, in any suitable manner. Some of the paragraphs below expressly refer to and further limit other paragraphs, providing without limitation examples of some of the suitable combinations. Each of the paragraphs including the term “substantially” may also be provided in the same form excepting that the term “substantially” is deleted.
A1. A method of manufacturing a duct segment, comprising:
wrapping a mandrel with a first thermoplastic film, where the mandrel is configured to define an inner mold line for a desired duct segment;
enveloping the wrapped mandrel with a reinforcing sheath for the desired duct segment, where the reinforcing sheath incorporates reinforcing fibers;
wrapping the enveloped mandrel with a second thermoplastic film to form a multilayer duct segment precursor;
enclosing the mandrel and multilayer duct segment precursor within an outer mold configured to define an outer mold line for the duct segment; and
heating the enclosed multilayer duct segment precursor at a temperature and for a time sufficient to fuse the layers of the multilayer duct segment precursor; and
cooling the resulting duct segment.
A2 The method of paragraph A1, further comprising preforming the reinforcing sheath.
A3. The method of paragraph A2, wherein preforming the reinforcing sheath includes weaving the reinforcing fibers to form a woven material, and forming the reinforcing sheath from the woven material.
A4. The method of paragraph A2, wherein preforming the reinforcing sheath includes knitting the reinforcing fibers to form a knitted material, and forming the reinforcing sheath from the knitted material.
A5. The method of paragraph A1, wherein enveloping the wrapped mandrel with the reinforcing sheath includes enveloping the wrapped mandrel with a reinforcing sheath that is seamless.
A6. The method of paragraph A1, wherein enveloping the wrapped mandrel with the reinforcing sheath includes enveloping the wrapped mandrel with a reinforcing sheath that substantially conforms to a shape of the wrapped mandrel.
A7. The method of paragraph A1, wherein enveloping the wrapped mandrel with the reinforcing sheath includes enveloping a nonlinear mandrel with a complementarily nonlinear reinforcing sheath.
A8. The method of paragraph A1, wherein enveloping the wrapped mandrel with the reinforcing sheath includes enveloping a branched mandrel with a complementarily branched reinforcing sheath.
A9. The method of paragraph A1, wherein enveloping the wrapped mandrel includes enveloping a mandrel that has a nonuniform cross-section with a complementary reinforcing sheath that defines a tube having a nonuniform diameter.
A10. The method of paragraph A1, wherein enclosing the mandrel and multilayer duct precursor includes expanding the mandrel.
A11. The method of paragraph A10, wherein the mandrel comprises a silicone-based polymer, and expanding the mandrel includes at least partially inflating the mandrel while it is enclosed within the outer mold.
A12. The method of paragraph A1, wherein wrapping the mandrel with the first thermoplastic film includes wrapping the mandrel with an elongate strip of the first thermoplastic film in an overlapping spiral.
A13. The method of paragraph A1, further comprising enveloping at least a portion of the multilayer duct segment precursor with one or more additional reinforcing fabric layers, and wrapping each additional reinforcing fabric layer with an additional thermoplastic film prior to enclosing the mandrel and multilayer duct segment precursor within the outer mold.
A14. The method of paragraph A1, wherein enveloping the wrapped mandrel with the reinforcing sheath includes enveloping the wrapped mandrel with a reinforcing sheath that incorporates one or more reinforcing fibers that include organic polymers, carbon fibers, glass fibers, ceramic fibers, or metal wire.
A15. The method of paragraph A1, wherein enveloping the wrapped mandrel with the reinforcing sheath includes enveloping the wrapped mandrel with a reinforcing sheath that incorporates one or more reinforcing fibers that include poly paraphenylene terephthalamide polymers.
A16. The method of paragraph A1, wherein heating the enclosed multilayer duct segment precursor includes heating the enclosed multilayer duct segment precursor to a temperature above a glass transition temperature of the first and second thermoplastics.
A17. The method of claim A1, wherein wrapping the mandrel with the first thermoplastic film or wrapping the enveloped mandrel with the second thermoplastic film includes wrapping the mandrel with a film that includes one or more of a poly(methyl methacrylate) polymer, an acrylonitrile butadiene styrene polymer, a polyamide polymer, a polylactic acid polymer, a polybenzimidazole polymer, a polycarbonate polymer, a polyether sulfone polymer, a polyetherether ketone polymer, a polyether ketone ketone polymer, a polyetherimide polymer, a polyethylene polymer, a polyphenylene sulfide polymer, a polypropylene polymer, a polystyrene polymer, a polyvinyl chloride polymer, a polytetrafluoroethyelene polymer, a polyvinyl fluoride polymer, and a polyvinylidene fluoride polymer.
A18. The method of paragraph A1, wherein wrapping the mandrel with the first thermoplastic film or wrapping the enveloped mandrel with the second thermoplastic film includes wrapping the mandrel with a thermoplastic film that includes a polyether ether ketone polymer.
B1. A duct segment having a duct wall that defines a channel for conveying a fluid, the duct wall comprising:
a sheath of reinforcing fabric, the reinforcing fabric incorporating multiple reinforcing fibers; and
a thermoplastic fused with the sheath of reinforcing fabric.
B2. The duct segment of paragraph B1, wherein the reinforcing fabric is prepared by weaving or knitting the reinforcing fibers.
B3. The duct segment of paragraph B1, wherein the duct wall has a thickness in the range of 0.02 to 0.08 inches (0.5 to 2 mm).
B4. The duct segment of paragraph B1, wherein the duct wall defines a channel that is 12 inches (305 mm) in diameter or less.
B5. The duct segment of paragraph B1, wherein the duct segment includes at least one of an elbow, a joggle, a branch, or a change in cross-section.
B6. The duct segment of paragraph B1, wherein the reinforcing fibers include one or more of organic polymers, carbon fibers, glass fibers, ceramic fibers, or metal wire.
B7. The duct segment of paragraph B1, wherein the thermoplastic includes one or more of polyethylene polymers, polystyrene polymers, polyamide polymers, or polyvinyl polymers.
B8. The duct segment of paragraph B1, wherein the thermoplastic is selected to be heat-resistant.
B9. The duct segment of paragraph B1, wherein the thermoplastic is selected to have a glass transition temperature above 250° F. (120° C.).
B10. The duct segment of paragraph B1, wherein the thermoplastic includes a polyether ether ketone polymer, a polycarbonate polymer, a polysulfone polymer, a polyetherimide polymer, a polyethersulfone polymer, or a polyamideimide polymer, and the reinforcing fibers include a poly paraphenylene terephthalamid polymer.
C1. A duct segment, prepared by:
wrapping an internal form with a thermoplastic film;
slipping a reinforcing sheath over the wrapped internal form;
wrapping the reinforcing sheath with a second thermoplastic film;
enclosing the wrapped internal form within an outer mold;
heating the mold to fuse the thermoplastic films with the reinforcing sheath, and
cooling the resulting fused duct segment.
C2. The duct segment of paragraph C1, further comprising applying one or more additional reinforcing fabric layers to the wrapped internal form, and wrapping each additional reinforcing fabric layer with an additional thermoplastic film, prior to enclosing the wrapped internal form within the outer mold.

### Advantages, Features, Benefits

The different examples of reinforced thermoplastic duct segments and their manufacture described herein provide several advantages over previous ducts and manufacturing methods for such ducts. More specifically, the presently described methods may permit for fast and cost-effective duct manufacture, and may permit the preparation of duct segments having a high strength-to-weight ratio. Further, by permitting the use of thermoset plastics to form the matrix of the duct segments, the selection of appropriate thermoplastic(s) permit the manufacture of duct segments having preselected physical and chemical properties, such as resistance to high temperatures, a lack of porosity to resist leakage, or resistance to corrosion. In addition, the methods described herein may be applied to any other industry or material where the rapid preparation of custom duct segments may be advantageous.

### CONCLUSION

The disclosure set forth above may encompass multiple distinct inventions with independent utility. Although each of these inventions has been disclosed in its preferred form(s), the specific examples thereof as disclosed and illustrated herein are not to be considered in a limiting sense, because numerous variations are possible. The subject matter of the inventions includes all novel and nonobvious combinations and subcombinations of the various elements, features, functions, and/or properties disclosed herein. The following claims particularly point out certain combinations and subcombinations regarded as novel and nonobvious. Inventions embodied in other combinations and subcombinations of features, functions, elements, and/or properties may be claimed in applications claiming priority from this or a related application. Such claims, whether directed to a different invention or to the same invention, and whether broader, narrower, equal, or different in scope to the original claims, also are regarded as included within the subject matter of the present disclosure.

What is claimed is:

1. A method of manufacturing a duct segment, comprising:
wrapping a mandrel with a first thermoplastic film, where the mandrel is configured to define an inner mold line for a desired duct segment;
enveloping the wrapped mandrel with a reinforcing sheath for the desired duct segment, where the reinforcing sheath incorporates reinforcing fibers;
wrapping the enveloped mandrel with a second thermoplastic film to form a multilayer duct segment precursor;
enclosing the mandrel and multilayer duct segment precursor within an outer mold configured to define an outer mold line for the duct segment; and
heating the enclosed multilayer duct segment precursor at a temperature and for a time sufficient to fuse the layers of the multilayer duct segment precursor; and
cooling the resulting duct segment.

2. The method of claim 1, further comprising preforming the reinforcing sheath.

3. The method of claim 2, wherein preforming the reinforcing sheath includes weaving the reinforcing fibers to form a woven material, and forming the reinforcing sheath from the woven material.

4. The method of claim 2, wherein preforming the reinforcing sheath includes knitting the reinforcing fibers to form a knitted material, and forming the reinforcing sheath from the knitted material.

5. The method of claim 1, wherein enveloping the wrapped mandrel with the reinforcing sheath includes enveloping the wrapped mandrel with a reinforcing sheath that is seamless.

6. The method of claim 1, wherein enveloping the wrapped mandrel with the reinforcing sheath includes enveloping the wrapped mandrel with a reinforcing sheath that substantially conforms to a shape of the wrapped mandrel.

7. The method of claim 1, wherein the mandrel comprises a silicone-based polymer, enclosing the mandrel and multilayer duct precursor includes expanding the mandrel by at least partially inflating the mandrel while it is enclosed within the outer mold.

8. The method of claim 1, wherein wrapping the mandrel with the first thermoplastic film includes wrapping the mandrel with an elongate strip of the first thermoplastic film in an overlapping spiral.

9. The method of claim 1, further comprising enveloping at least a portion of the multilayer duct segment precursor with one or more additional reinforcing fabric layers, and wrapping each additional reinforcing fabric layer with an additional thermoplastic film prior to enclosing the mandrel and multilayer duct segment precursor within the outer mold.

10. The method of claim 1, wherein enveloping the wrapped mandrel with the reinforcing sheath includes enveloping the wrapped mandrel with a reinforcing sheath that incorporates one or more reinforcing fibers that include organic polymers, carbon fibers, glass fibers, ceramic fibers, or metal wire.

11. The method of claim 1, wherein enveloping the wrapped mandrel with the reinforcing sheath includes enveloping the wrapped mandrel with a reinforcing sheath that incorporates one or more reinforcing fibers that include poly paraphenylene terephthalamide polymers.

12. The method of claim 1, wherein wrapping the mandrel with the first thermoplastic film or wrapping the enveloped mandrel with the second thermoplastic film includes wrapping the mandrel with a thermoplastic film that includes a polyether ether ketone polymer.

13. The method of claim 1, wherein heating the enclosed multilayer duct segment precursor includes heating the enclosed multilayer duct segment precursor to a temperature above a glass transition temperature of the first and second thermoplastics.

14. A duct segment having a duct wall that defines a channel for conveying a fluid, the duct wall comprising:
a sheath of reinforcing fabric, the reinforcing fabric incorporating multiple reinforcing fibers; and
a thermoplastic fused with the sheath of reinforcing fabric.

15. The duct segment of claim 14, wherein the duct wall has a thickness in the range of 0.5 to 2 mm.

16. The duct segment of claim 14, wherein the duct wall defines a channel that is 300 mm in diameter or less.

17. The duct segment of claim 14, wherein the duct segment includes at least one of an elbow, a joggle, a branch, or a change in cross-section.

18. The duct segment of claim 14, wherein the reinforcing fibers include one or more of organic polymers, carbon fibers, glass fibers, ceramic fibers, or metal wire.

19. The duct segment of claim 14, wherein the thermoplastic includes one or more of polyethylene polymers, polystyrene polymers, polyamide polymers, or polyvinyl polymers.

20. The duct segment of claim 19, wherein the thermoplastic is selected to be heat-resistant.

21. The duct segment of claim 14, wherein the thermoplastic is selected to have a glass transition temperature above 120° C.

22. A duct segment, prepared by:
wrapping an internal form with a thermoplastic film;
slipping a reinforcing sheath over the wrapped internal form;
wrapping the reinforcing sheath with a second thermoplastic film;
enclosing the wrapped internal form within an outer mold;
heating the mold to fuse the thermoplastic films with the reinforcing sheath, and
cooling the resulting fused duct segment.

23. The duct segment of claim 22, further comprising applying one or more additional reinforcing fabric layers to the wrapped internal form, and wrapping each additional reinforcing fabric layer with an additional thermoplastic film, prior to enclosing the wrapped internal form within the outer mold.
